(19) United States
(12) Patent Application Publication
(10) Pub. No.: US 2011/0112900 A1
(43) Pub. Date: May 12, 2011

(54) MIDFLIGHT ONLINE ADVERTISEMENT CAMPAIGN OPTIMIZER

(75) Inventor: Mehul Sanghavi, Sunnyvale, CA (US)

(73) Assignee: Yahoo! Inc., Sunnyvale, CA (US)

(21) Appl. No.: 12/615,686

(22) Filed: Nov. 10, 2009

(51) Int. Cl. G06Q 30/00

(52) U.S. Cl. 705/14.43

(57) ABSTRACT

Methods and systems are provided for optimization of online advertising campaigns. Methods and systems are provided in which, in manner that may be partially or fully automated, during a period of advertisement serving in fulfillment of an agreement with an advertiser, allocated anticipated impressions are shifted from one portion of a topic-related taxonomy to another, such as from an overperforming node in the taxonomy to an underperforming node. Such shifting may be done using real-time or frequent advertisement performance monitoring and forecasting, but may be bounded or guided by a set of rules that the advertiser may provide.

### BACKGROUND

Online advertising continues to grow in scale, complexity and importance.

Optimization of such campaigns can allow advertisers to best reach their goals and maximize return on their advertising spend. Ideally, advertisers need tools that provide the highest degree of optimization achievable while providing advertisers with a high degree of control and customization as well as options such as automatization options.

There is a need for methods, systems, and tools for optimization of online advertising campaigns.

### SUMMARY

Some embodiments of the invention provide methods and systems for optimization of online advertising campaigns. Methods and systems are provided in which, in a partially or fully automated manner, during a period of advertisement serving in fulfillment of an agreement with an advertiser, allocated anticipated impressions are shifted from one portion of a topic-related taxonomy to another, such as from an overperforming node in the taxonomy to an underperforming node. Such shifting may be done using real-time or near real-time advertisement performance monitoring and forecasting, and with little or no input from the advertiser during the period. The shifting may, however, be bounded or guided by a set of rules that the advertiser may partially or fully provide prior to the period. In some embodiments, an agreement or contract may be automatically or partially automatically modified based on such shifting, and such modification may also be bounded or guided by previously provided or obtained rules. Shifting between taxonomical nodes, along with frequent advertisement performance monitoring and forecasting during the period, allow for a high degree of advertisement campaign optimization. Furthermore, such optimization can be achieved while allowing a high degree of advertiser guidance or control, yet with relatively little advertiser involvement.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention;

FIG. 5 is a flow diagram illustrating a method according to one embodiment of the invention;

FIG. 6 is a flow diagram illustrating a method according to one embodiment of the invention; and

FIG. 7 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Some embodiments of the invention provide methods and systems for optimization of online advertising campaigns. Methods and systems are provided in which, in a manner that may be partially or fully automatic, during a period of advertisement serving in fulfillment of an agreement with an advertiser (which is sometimes referred to hereinafter as “midflight”), allocated anticipated impressions are shifted from one portion of a topic-related taxonomy to another, such as from an overperforming node in the taxonomy to an underperforming node. The allocated anticipated impressions may be related to an obligation under the agreement to provide a certain number of impressions under certain conditions.

Shifting between taxonomical nodes, according to some embodiments, may be done using real-time, near real-time, or frequent advertisement performance monitoring and forecasting, such as machine learning-based forecasting. In some embodiments, nodes with particular characteristics, such as nodes with a history of volatility, or large swings in predictability, may be monitored more closely or more frequently than other nodes. The shifting may be determined and performed with little or no input from the advertiser during the period, but may be bounded or guided by a set of rules that the advertiser may partially or fully provide prior to the period.

In some embodiments, an agreement or contract may be partially automatically or fully automatically modified based on such shifting, and such modification may also be bounded or guided by previously provided or obtained rules. Such contract modification may be done based on real-time or very frequent monitoring, and may itself be done in real-time or very frequently. In some embodiments, contract modification can be handled separately and using a separate component or application than a campaign optimization component, although information and updates may be shared. In some embodiments, contract modifications are proposed, suggested or recommended to an advertiser, such as for confirmation, before being implemented.

In some embodiments, prior to the start of the period, or pre-flight, an advertiser provides parameters, rules, guidelines or boundaries regarding permissible shifting as well as permissible contract modification. This information may be input to a campaign optimizer component as well as a contract management component.

Some embodiments allow some degree of modification of campaigns, according to or bounded by the advertiser's initially input preferences or “weigh in”, without the need for advertisers to provide input or instructions in mid-flight.

Some embodiments, in addition to helping advertisers meet their campaign goals, also allow an advertising network to obtain information regarding long-term advertisement performance patterns in connection with taxonomical nodes. This information can be used or mined, for example, to refine or normalize the taxonomy. Still further, in some embodiments, by decreasing overperformance with regard to some nodes, potentially lower quality impressions, which may be served to overperforming nodes, can be reduced or avoided.

Generally, advertisers need to ensure that their campaigns are delivered upon correctly, on time, and with the highest performance achievable. Underdelivery with regard to a campaign or contract with an advertiser is inefficient and can lead to loss of profit as well as embarrassment. Some embodiments of the invention, including mid-flight optimization, effectively make the advertisement network “smarter” or better optimized, helping mitigate or eliminate these problems.

Some embodiments provide something similar to an “autopilot”, or partial autopilot, feature for advertisers, in connection with their advertising campaigns, which can allow for “flight and forget” trafficking, after input of initial campaign heuristics. Additionally, embodiments of the invention can allow for better advertising inventory and supply management for parties such as publishers and other campaign facilitators, allowing surfacing of advertisement inventory to areas where better performance will be achieved.

According to some embodiments, Shifting of allocated anticipated impressions between taxonomical nodes, along with frequent advertisement performance monitoring and forecasting during the period, allows for a high degree of advertisement campaign optimization. Furthermore, such optimization can be achieved while allowing a high degree of advertiser guidance or control, yet with relatively little advertiser involvement.

In some embodiments, an advertiser does not even need to submit initial preferences or rules, or may only provide general boundaries or guidelines. Instead, an advertiser can simply opt to allow the campaign optimizer program to determine and implement measures including shifts, to optimize the advertising campaign, or elements thereof. In some embodiments, instead of providing specific rules, advertisers can merely provide some bounds, such as upper and lower limits or bounds, on optimization measures, and allow the campaign optimizer to handle the rest.

Furthermore, in some embodiments, rules affecting shifting, targeting, or contract modification may be automatically or partially automatically determined. This can include use of a component such as a rules engine.

In some embodiments, advertisers can specify parameters including targeting expansion parameters that may be used in campaign optimization in mid-flight, such as before shifting.

Some embodiments include shifting of anticipated impressions between nodes of a topical taxonomy. The taxonomy may be related to the subject matter, coverage, or nature of the associated advertisements. Furthermore, taxonomies may be hierarchical or partially hierarchical in nature, so that some nodes may be subnodes of one or more other nodes, etc., and more complex taxonomy structures are also contemplated.

Some embodiments include real-time or frequent midflight monitoring of advertisement performance, such as tracking of click through rates associated with advertisements served during a part of the associated period. Such monitoring can be, for example, on the order of hours or minutes or even more frequently. This may include tracking of advertisement performance associated with particular taxonomical nodes. In this manner, performance associated with particular nodes can be assessed. Overperforming or underperforming nodes may be identified, relative to terms of an advertiser agreement or other standards or expectations, such as, for example, in relation to average node performance or other across the board comparisons.

In some embodiments, based in part on monitoring of advertisement performance associated with particular nodes, one or more shifts or anticipated shifts of allocated anticipated impressions may be determined, stored, and implemented, including influencing future serving planning and serving.

Advertisement performance monitoring according to some embodiments can include monitoring of advertisement inventory in mid-flight. Furthermore, historical advertisement performance information, including the monitored information and potentially other historical performance information, can be used for various purposes. The performance information can be used for forecasting, such as machine-learning based or other statistical forecasting, in connection with advertisement serving, including in connection with particular nodes. Furthermore, the performance information can be used in identifying trending, including trending based at least in part on real-time or frequent monitoring, in connection with particular nodes. Forecasting, trending, and other information can be used, for example, in determination of appropriate shifts.

In some embodiments, a set of rules or parameters is used in determining, or bounding determination of, things such as permissible shifting, or nodes between which shifting is allowed, or permissible node levels for shifting, etc. Rules can also include branching preferences in connection with shifting between particular nodes, node levels, etc. Such rules may be obtained, in whole or in part, from an advertiser including, possibly, a proxy of an advertiser), or with input from an advertiser. For example, in some embodiments, prior to flight, an advertiser inputs rules governing permissible shifting, such as by specifying nodes between which shifting is allowed. Other parameters can also be provided, such as how much shifting is allowed, etc. In some embodiments, rules can also be generated, provided or modified pre-flight or in midflight.

Furthermore, in addition to shifting, rules can also govern various forms of expansion or contraction of a targeted user segment. For example, in addition to shifting between nodes, a targeted group can be expanded by relaxing various targeting parameters, such as geotargeting, behavioral targeting, etc.

In some embodiments, a rules engine can be utilized in generating or implementing rules. The rules engine may communicate with other applications or elements, including a campaign optimizer element and a contract management element.

In some embodiments, shifting in accordance with rules is determined and implemented without input from an advertiser. However, in some embodiments, recommendations or suggestions are provided to advertisers, which must be agreed to or confirmed before implementation.

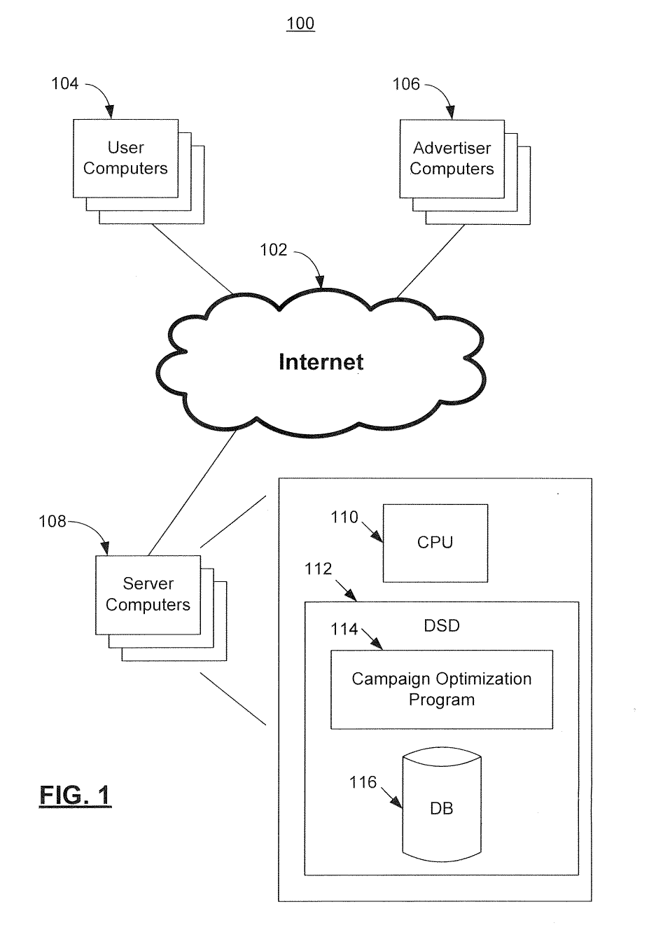

FIG. 1 is a distributed computer system 100 according to one embodiment of the invention. The system 100 includes user computers 104, advertiser computers 106 and server computers 108, all coupled or coupleable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Campaign Optimization Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

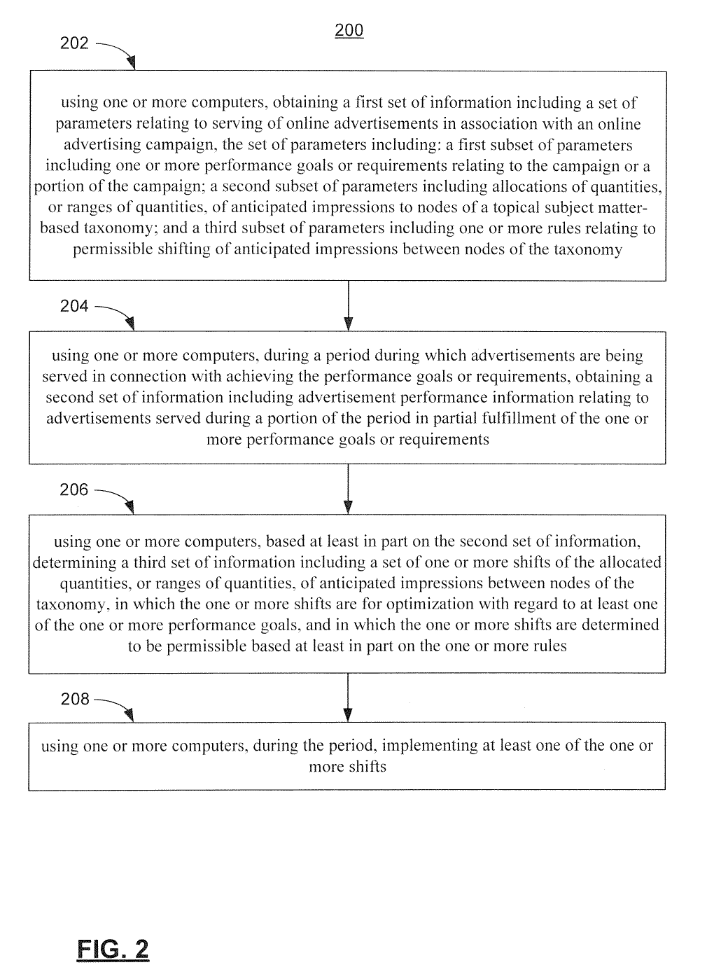

FIG. 2 is a flow diagram of a method 200 according to one embodiment of the invention. At step 202, using one or more computers, a first set of information is obtained, including a set of parameters relating to serving of online advertisements in association with an online advertising campaign. The set of parameters includes: a first subset of parameters including one or more performance goals or requirements relating to the campaign or a portion of the campaign; a second subset of parameters including allocations of quantities, or ranges of quantities, of anticipated impressions to nodes of a topical subject matter-based taxonomy; and a third subset of parameters including one or more rules relating to permissible shifting of anticipated impressions between nodes of the taxonomy.

At step 204, using one or more computers, during a period during which advertisements are being served in connection with achieving the performance goals or requirements, a second set of information is obtained including advertisement performance information relating to advertisements served during a portion of the period in partial fulfillment of the one or more performance goals or requirements.

At step 206, using one or more computers, based at least in part on the second set of information, a third set of information is determined including a set of one or more shifts of the allocated quantities, or ranges of quantities, of anticipated impressions between nodes of the taxonomy. The one or more shifts are for optimization with regard to at least one of the one or more performance goals, and the one or more shifts are determined to be permissible based at least in part on the one or more rules.

At step 208, using one or more computers, during the period, at least one of the one or more shifts are implemented.

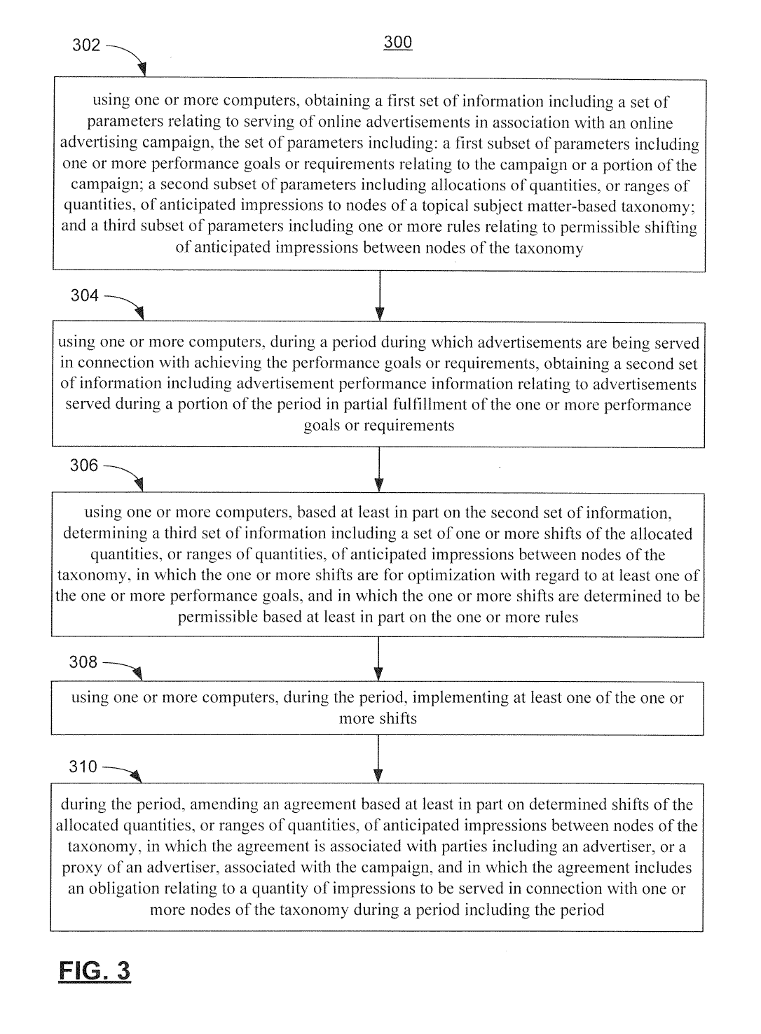

FIG. 3 is a flow diagram of a method 300 according to one embodiment of the invention. At step 302, using one or more computers, a first set of information is obtained including a set of parameters relating to serving of online advertisements in association with an online advertising campaign. The set of parameters includes: a first subset of parameters including one or more performance goals or requirements relating to the campaign or a portion of the campaign; a second subset of parameters including allocations of quantities, or ranges of quantities, of anticipated impressions to nodes of a topical subject a r-based taxonomy; and a third subset of parameters including one or more rules relating to permissible shifting of anticipated impressions between nodes of the taxonomy.

At step 304, using one or more computers, during a period during which advertisements are being served in connection with achieving the performance goals or requirements, a second set of information is obtained including advertisement performance information relating to advertisements served during a portion of the period in partial fulfillment of the one or more performance goals or requirements.

At step 306, using one or more computers, based at least in part on the second set of information, a third set of information is determined including a set of one or more shifts of the allocated quantities, or ranges of quantities, of anticipated impressions between nodes of the taxonomy. The one or more shifts are for optimization with regard to at least one of the one or more performance goals, and the one or more shifts are determined to be permissible based at least in part on the one or more rules.

At step 308, using one or more computers, during the period, at least one of the one or more shifts are implemented.

At step 310, during the period, an agreement is amended based at least in part on determined shifts of the allocated quantities, or ranges of quantities, of anticipated impressions between nodes of the taxonomy. The agreement is associated with parties including an advertiser, or a proxy of an advertiser, associated with the campaign. The agreement includes an obligation relating to a quantity of impressions to be served in connection with one or more nodes of the taxonomy during a period including the period.

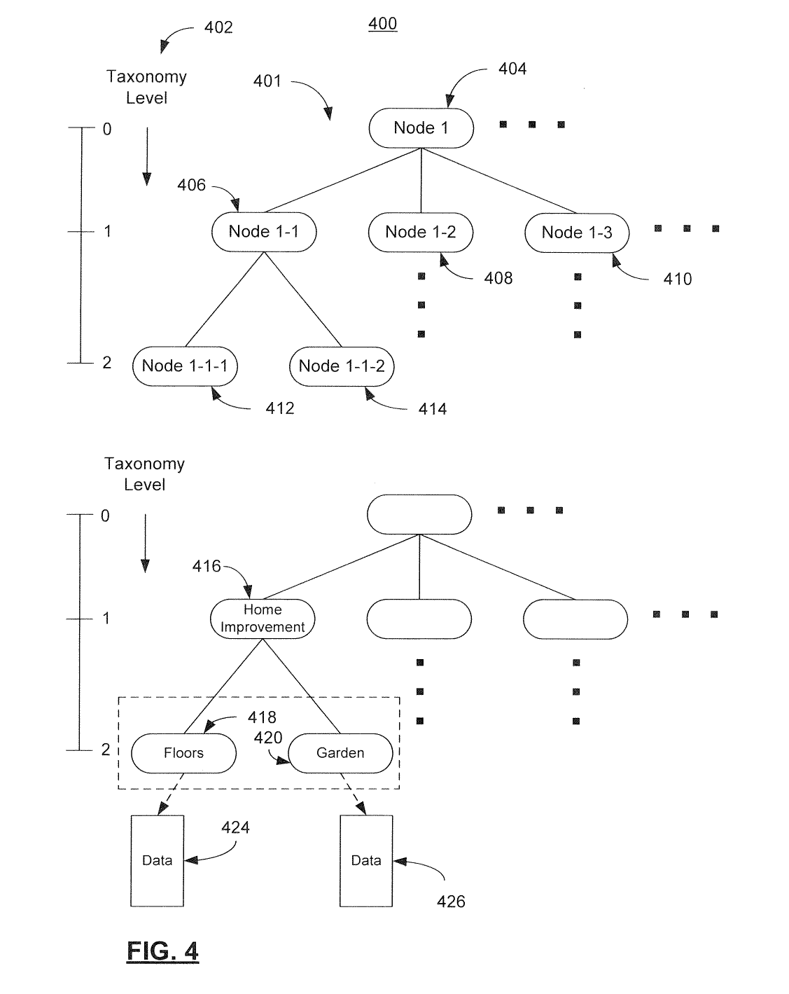

FIG. 4 is a conceptual block diagram 400 according to one embodiment of the invention. Specifically, FIG. 4 is a simplified depiction of a portion of one embodiment of a subject matter or topical taxonomy 401, with which advertisements or the subjects of advertisements may be associated.

A set of taxonomical hierarchical levels 402 is indicated, including levels 0, 1 and 2. Node 1 404 may be a level 0 or “root” node, comprehending all lower nodes branching directly or indirectly from it. Level 1 nodes include node 1-1 406, node 1-2 408, and node 1-3 410, which may be subsets of node 1 404. As depicted, level 2 nodes include nodes 1-1-1 412 and 1-1-2 414, which are subnodes of node 1-1 406.

The node labeled “home improvement” 416, which may be a topic associated with the node, provides a specific example of the node 1-1 406. As depicted, a node labeled “floors” 418 and a node labeled “garden” 420 are examples of the subnode 1-1-1 412 and the subnode 1-1-2 414. In this example, the nodes 418 and 420 are associated with home improvement in the areas of flooring and gardening, respectively.

As depicted, the nodes 418 and 420 may be associated with monitored, collected and stored data 424, 426, such as data that may be collected in real-time or very frequently and in mid-flight, and associated with the particular node. The data 424, 426 can include log data, such as periodically collected advertisement delivery data, which may include data over repeating periods such as minutes, hours, days, weeks, or months. The data 424, 426 may also include scheduling or booking data for any of various upcoming periods, including breakdowns according to groups such as targeting groups. The data may also include run-time collected data on impressions served in connection with the node during past periods of various lengths. The data may further include a prediction, such as a real-time prediction, based on various collected and monitored data.

As depicted, the data 424, 426 indicates predicted underdelivery for a particular future period for the “flooring” node 418, and predicted overdelivery for the particular future period for the “garden” node 420. As such, shifting may be determined from node 420 to node 418.

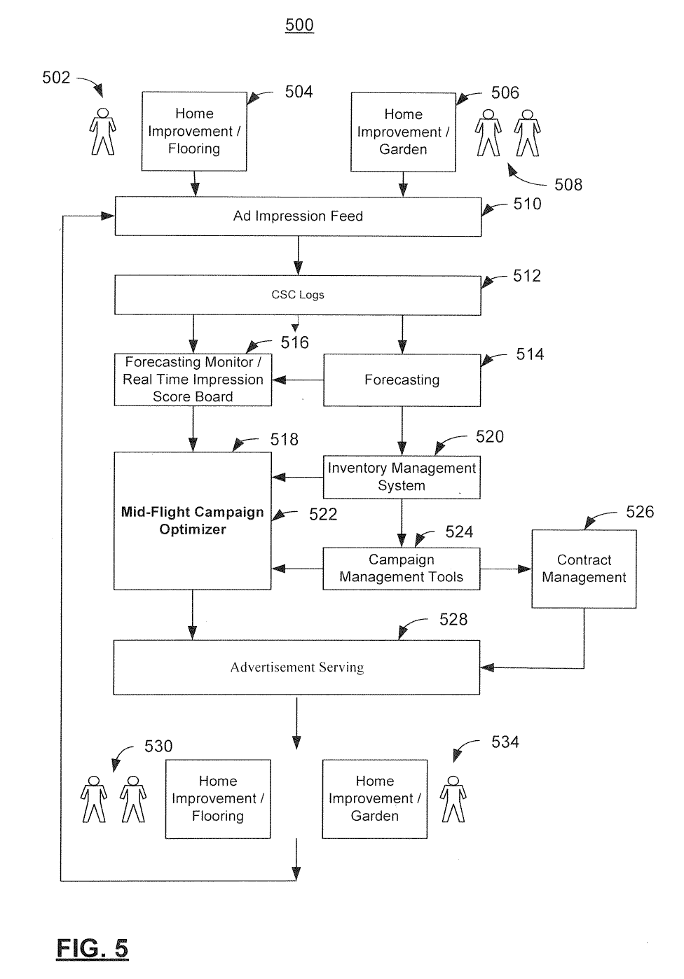

FIG. 5 is a flow diagram of a method 500 according to one embodiment of the invention, such as a method 500 in connection with the nodes 418, 420 as depicted in FIG. 4, which are depicted in FIG. 5 as blocks 504 and 506.

Overall, the method 500 includes data monitoring, forecasting and prediction in connection with the nodes 504 and 506, resulting in shifting from the overperforming “garden” node 506 to the underperforming “flooring” node 504. This is represented, pre-shifting, by a single figure 502 (representing underperformance), associated with the “flooring” node 504, and a set of two figures 508 (representing overperformance), associated with the “garden” node 506. Post-shifting, a set of two figures 530 is associated with the “flooring” node 504, and a single figure 534 is associated with the “garden” node 506, indicating a shift in allocated anticipated impressions from the “garden” node 506 to the “flooring” node 504.

More specifically, the method 500 includes the following. At step 510, an advertisement impression data feed is obtained in connection with the nodes 504, 506.

At step 512, client side counting (CSC) logs are obtained, regarding delivered impression counting.

At step 514, forecasting is performed and also, at step 516, a forecasting monitor and real-time impression scoreboard is maintained.

Steps 520 and 524 represent usage of inventory management and campaign management tools, respectively.

Various collected, obtained or determined data feeds into a midflight campaign optimizer component 518, which may determine shifting, and a contract management component 526, which may modify contracts.

Data, which may include determinations or instructions, from the midflight campaign optimizer component 518 and the contract management component 526 feeds into and informs advertisement serving at step 528, including serving in connection with the nodes 504, 506.

Following advertisement serving, the method 500 returns to step 510.

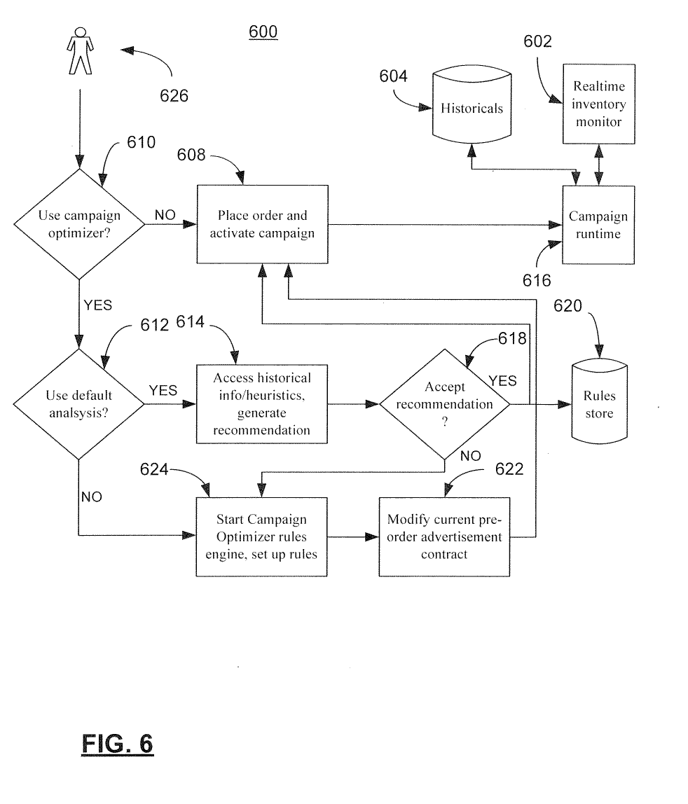

FIG. 6 is a flow diagram of a method 600 according to one embodiment of the invention. FIG. 6 relates to setting up of rules that pertain to campaign optimization, including shifting, and contract management, including contract modification.

At step 610, an advertiser 626 decides whether to use a campaign optimizer or, at step 612, whether to use defaults, with regard to obtaining or generating rules associated with campaign optimization and contract modification.

If use of the campaign optimizer is not chosen at step 610, then the method 600 proceeds to step 608, including order placement and campaign activation, and then to campaign runtime at step 616. Information from the ongoing campaign is fed into a historical database 604 and a real-time advertisement inventory monitor 602.

If use of the campaign optimizer is selected at step 610, then the method 600 proceeds to step 612, at which the advertiser decides whether to use default analysis.

If default analysis is selected at step 612, then the method 600 proceeds to step 614, at which historical information and heuristics are obtained, and a recommendation is generated regarding one or more rules. At step 618, if the recommendation is accepted by the advertiser, a rule is generated and stored in a rules store database 620, and the method 600 proceeds to step 608, described above. If the recommendation is not accepted at step 618, then the method 600 proceeds to step 624, as described as follows.

If default analysis is not selected at step 612, of if the recommendation is not accepted at step 618, then the method 600 proceeds to step 624, at which a campaign optimizer rules engine is started and rules are set up. Next, at step 622, a current pre-order contract is modified accordingly, following which the method 600 proceeds to step 608, described above.

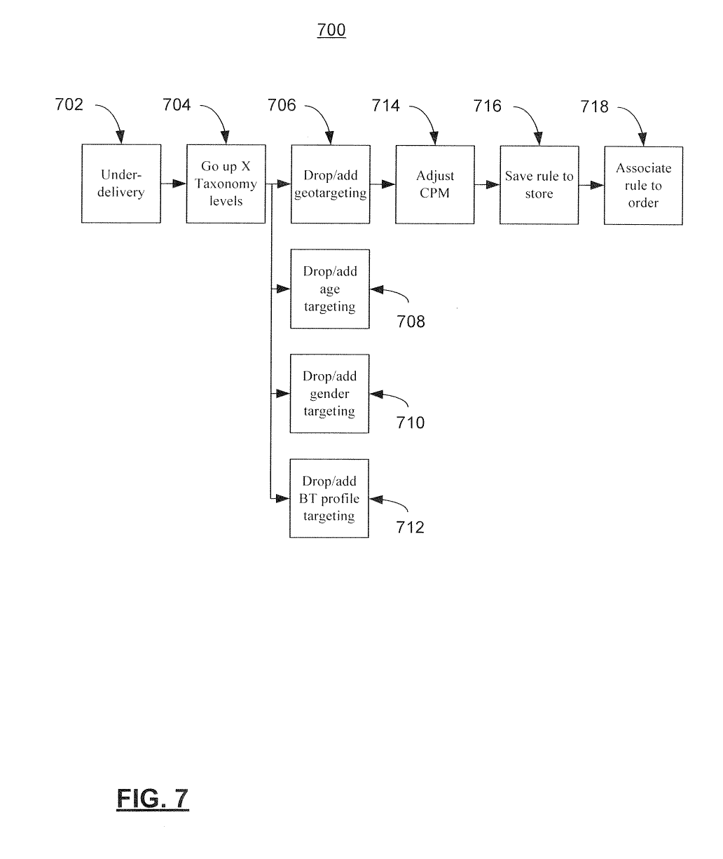

FIG. 7 is a flow diagram of a method 700 according to one embodiment of the invention. The method 700 is a simple example of a method that may be performed by or using a campaign optimizer according to one embodiment of the invention. The method 700 represents an example of a rules-building feature of the campaign optimizer. The rules may be used to guide shifting or targeting modification, or both.

At step 702, underdelivery is detected with regard to a particular node (or set of nodes, or other taxonomical portion). At step 704, a portion of anticipated impressions allocated to the underperforming node are shifted to a higher level node.

At steps 706, 708, 710, and 712, any of various targeting parameters may be added or dropped, for example, in a particular order until some goal or range is reached, including, respectively, geotargeting, age targeting, gender targeting, or behavioral profile targeting.

At step 714, a cost per million impressions (CPM) is adjusted in view of the shift.

At step 716, the shifting and targeting modifications are embodied in a rule, and the rule is stored in a database.

At step 718, the rule is associated with an advertiser order.

While the invention is described with reference to the above drawings, the drawings are intended to be illustrative, and the invention contemplates other embodiments within the spirit of the invention.

1. A method comprising:
using one or more computers, obtaining a first set of information comprising a set of parameters relating to serving of online advertisements in association with an online advertising campaign, the set of parameters comprising:
a first subset of parameters comprising one or more performance goals or requirements relating to the campaign or a portion of the campaign;
a second subset of parameters comprising allocations of quantities, or ranges of quantities, of anticipated impressions to nodes of a topical subject matter-based taxonomy; and
a third subset of parameters comprising one or more rules relating to permissible shifting of anticipated impressions between nodes of the taxonomy;
using one or more computers, during a period during which advertisements are being served in connection with achieving the performance goals or requirements, obtaining a second set of information comprising advertisement performance information relating to advertisements served during a portion of the period in partial fulfillment of the one or more performance goals or requirements;
using one or more computers, based at least in part on the second set of information, determining a third set of information comprising a set of one or more shifts of the allocated quantities, or ranges of quantities, of anticipated impressions between nodes of the taxonomy, wherein the one or more shifts are for optimization with regard to at least one of the one or more performance goals, and wherein the one or more shifts are determined to be permissible based at least in part on the one or more rules; and
using one or more computers, during the period, implementing at least one of the one or more shifts.

2. The method of claim 1, comprising serving advertisements at least in part based on the at least one of the one or more shifts.

3. The method of claim 1, wherein the third set of information is determined at least in part based on determined forecasting information relating to advertisement performance, and wherein the forecasting information is determined based at least in part on the advertisement performance information, and wherein the performance information comprises performance information in connection with one or more nodes of the taxonomy.

4. The method of claim 1, wherein the one or more performance goals or requirements are impression-based and span a plurality of nodes of the taxonomy.

5. The method of claim 1, comprising:
during the period, determining a first one or more nodes of the taxonomy associated with underperformance in connection with serving of advertisements during a portion of the period, relative to at least one of the one or more performance goals or requirements; and
during the period, determining a second one or more nodes of the taxonomy associated with underperformance in connection with serving of advertisements during a portion of the period, relative to at least one of the one or more performance goals or requirements;
wherein determining the set of one or more shifts comprises determining a shift from the first one or more nodes to the second one or more nodes.

6. The method of claim 1, comprising, during the period, presenting the at least one shift to an advertiser, or a proxy of an advertiser, for approval prior to implementation.

7. The method of claim 1, comprising, at a plurality of different times during the period:
obtaining updated advertisement performance information relating to advertisements served during a portion of the period in partial fulfillment of the one or more performance goals or requirements; and
determining and implementing shifts of the allocated quantities, or ranges of quantities, of anticipated impressions between nodes of the taxonomy, based at least in part on the updated advertisement performance information.

8. The method of claim 1, comprising obtaining the second set of parameters associated with the topical subject matter taxonomy, wherein the topical subject-matter comprises a hierarchy of nodes, wherein some of the nodes include sets of two or more other of the nodes.

9. The method of claim 8, wherein obtaining the one or more rules relating to permissible shifting obtaining one or more rules relating to permissible shifting between subnodes of a higher level node, wherein the high level node includes nodes comprising the subnodes.

10. The method of claim 1, comprising, during the period, amending an agreement based at least in part on determined shifts of the allocated quantities, or ranges of quantities, of anticipated impressions between nodes of the taxonomy, wherein the agreement is associated with parties including an advertiser, or a proxy of an advertiser, associated with the campaign, and wherein the agreement includes an obligation relating to a quantity of impressions to be served in connection with one or more nodes of the taxonomy during a period including the period.

11. The method of claim 10, wherein amending the agreement comprises reflecting shifting of the allocated quantities, or ranges of quantities, of anticipated impressions between nodes of the taxonomy.

12. The method of claim 10, wherein amending the agreement is based at least in part on one or more permissible amendment parameters, and wherein the one or more permissible amendment parameters are supplied or agreed to, prior to the amending, by an advertiser, or proxy of an advertiser, associated with the campaign.

13. The method of claim 1, wherein at least a portion of the set of parameters are obtained from an advertiser, or proxy of an advertiser, associated with the campaign.

14. The method of claim 1, comprising offering an advertiser, or proxy of an advertiser, associated with the campaign options comprising a first option to approve suggested or recommended shifts prior to implementation and a second option to allow shifts to be implemented, within permissible parameters, without being presented to or specifically approved by the advertiser, or the proxy of the advertiser.

15. The method of claim 1, comprising storing the third set of information in one or more databases.

16. A system comprising:
one or more server computers connected to the Internet; and
one or more databases connected to the one or more servers;
wherein the one or more server computers are for:
obtaining a first set of information comprising a set of parameters relating to serving of online advertisements in association with an online advertising campaign, the set of parameters comprising:
a first subset of parameters comprising one or more performance goals or requirements relating to the campaign or a portion of the campaign;
a second subset of parameters comprising allocations of quantities, or ranges of quantities, of anticipated impressions to nodes of a topical subject matter-based taxonomy; and
a third subset of parameters comprising one or more rules relating to permissible shifting of anticipated impressions between nodes of the taxonomy;
during a period during which advertisements are being served in connection with achieving the performance goals or requirements, obtaining a second set of information comprising advertisement performance information relating to advertisements served during a portion of the period in partial fulfillment of the one or more performance goals or requirements;
based at least in part on the second set of information, determining a third set of information comprising a set of one or more shifts of the allocated quantities, or ranges of quantities, of anticipated impressions between nodes of the taxonomy, wherein the one or more shifts are for optimization with regard to at least one of the one or more performance goals, and wherein the one or more shifts are determined to be permissible based at least in part on the one or more rules; and
during the period, implementing at least one of the one or more shifts.

17. The system of claim 16, wherein the period is no longer than 4 hour.

18. The system of claim 16, wherein the period is no longer than 1 hour.

19. The system of claim 16, comprising storing the third set of information in at least one of the one or more databases.

20. A computer readable medium or media containing instructions for executing a method, the method comprising:
using one or more computers, obtaining a first set of information comprising a set of parameters relating to serving of online advertisements in association with an online advertising campaign, the set of parameters comprising:
a first subset of parameters comprising one or more performance goals or requirements relating to the campaign or a portion of the campaign;
a second subset of parameters comprising allocations of quantities, or ranges of quantities, of anticipated impressions to nodes of a topical subject matter-based taxonomy; and
a third subset of parameters comprising one or more rules relating to permissible shifting of anticipated impressions between nodes of the taxonomy;
using one or more computers, during a period during which advertisements are being served in connection with achieving the performance goals or requirements, obtaining a second set of information comprising advertisement performance information relating to advertisements served during a portion of the period in partial fulfillment of the one or more performance goals or requirements;
using one or more computers, based at least in part on the second set of information, determining a third set of information comprising a set of one or more shifts of the allocated quantities, or ranges of quantities, of anticipated impressions between nodes of the taxonomy, wherein the one or more shifts are for optimization with regard to at least one of the one or more performance goals, and wherein the one or more shifts are determined to be permissible based at least in part on the one or more rules;
using one or more computers, during the period, implementing at least one of the one or more shifts; and
during the period, amending an agreement based at least in part on determined shifts of the allocated quantities, or ranges of quantities, of anticipated impressions between nodes of the taxonomy, wherein the agreement is associated with parties including an advertiser, or a proxy of an advertiser, associated with the campaign, and wherein the agreement includes an obligation relating to a quantity of impressions to be served in connection with one or more nodes of the taxonomy during a period including the period.
